(19) United States
(12) Patent Application Publication
(10) Pub. No.: US 2009/0306249 A1
(43) Pub. Date: Dec. 10, 2009

(54) CEMENTITIOUS COMPOSITES

(75) Inventors: Thomas Lavin, Watchung, NJ (US); Houssam Toutanji, Madison, AL (US); John Gilbert, Huntsville, AL (US)

Correspondence Address: BROWN & MICHAELS, PC;400 M & T BANK BUILDING, 118 NORTH TIOGA ST, ITHACA, NY, 14850, US

(73) Assignee: OPTECHNOLOGY, INC., Huntsville, AL (US)

(21) Appl. No.: 12/474,810

(22) Filed: May 29, 2009

Related U.S. Application Data
(60) Provisional application No. 61/057,418, filed on May 30, 2008.

(51) Int. Cl. C04B 26/04

(52) U.S. Cl. 524/4; 524/8

(57) ABSTRACT

A method of improving the stress strain characteristics, the ductility, the energy absorbing characteristics, the fractal roughness and the material roughness of a cementitious mix includes adding at least 1%, by weight of the total weight of the cementitious mix of poly(vinyl butyrate) in addition to a reinforcing agent, preferably poly(vinyl alcohol). In a preferred embodiment, the amount of poly(vinyl butyrate) is about 40% to about 50%, by weight. This provides the optimum levels of performance of the characteristics listed above.

### REFERENCE TO RELATED APPLICATIONS

This application claims one or more inventions which were disclosed in Provisional Application No. 61/057,418, filed May 30, 2008, entitled “MATRIX DESIGN FOR STRATEGICALLY TUNED ABSOLUTELY RESILIENT STRUCTURES”. The benefit under 35 USC §119(e) of the United States provisional application is hereby claimed, and the aforementioned application is hereby incorporated herein by reference.

### ACKNOWLEDGMENT OF GOVERNMENT SUPPORT

This invention was made with Government support under Contract No. W31P4Q-06-C-0048, awarded by the Department of Defense. The government has certain rights in the invention.

### FIELD OF THE INVENTION

The present invention relates to high-performance cementitious composites. In particular, the present invention relates to a matrix design for a cementitious composite.

### SUMMARY OF THE INVENTION

A method of improving the stress strain characteristics, the ductility, the energy absorbing characteristics, the fractal roughness and the material roughness of a cementitious mix includes adding at least 1%, by weight of the total weight of the cementitious mix of poly(vinyl butyrate) in addition to a reinforcing agent, preferably poly(vinyl alcohol). In a preferred embodiment, the amount of poly(vinyl butyrate) is about 40% to about 50%, by weight. This provides the optimum levels of performance of the characteristics listed above.

In one embodiment, the cementitious mix includes a cement and an aggregate which includes at least 1% by weight of the total weight of the cementitious mix, of poly(vinyl butyral). In another embodiment, the method of increasing tensile strength of a cementitious mix includes adding poly(vinyl butyrate) to the cementitious matrix in an amount of at least 1%, by weight of the total weight of the cementitious mix. In yet another embodiment, the cementitious matrix includes a cement, an aggregate material, a fiber reinforcing material that binds to the aggregate material, and water. In another embodiment, the cementitious mix includes a cement and an aggregate including a material including surface hydroxyl groups and ether groups, where the material is present in an amount of at least 1% by weight of the weight of the cementitious mix.

### BRIEF DESCRIPTION ON THE DRAWINGS

FIG. 1 is a representation of the structure of poly(vinyl butyral) (PVB);

FIG. 2 is a representation of the hydrophilic-hydrophobic nature of PVB;

FIG. 3 is a graph of compressive strength of PVB concrete with no fibers added;

FIG. 4 is a representation of the experimental set up for third point bending;

FIG. 5 is a flexural stress-strain plot for PVB concrete specimens;

FIG. 6 is a flexural load-displacement plot for PVB concrete specimens;

FIG. 7 is a photograph showing fibers remaining intact along the fracture surface;

FIG. 8 is a graph of fracture toughness for PVB concrete specimens;

FIGS. 9A-9B show Charpy V-notch specimens;

FIG. 9C shows loading configurations (mm);

FIG. 10 is a graph of Mix 5 during compression;

FIGS. 11A-11B are photographs of Mix 5 after compression;

FIG. 12 is a graph of Mix 7 during compression;

FIG. 13 is a photograph of Mix 7 after compression;

FIG. 14 is a graph of force versus displacement for a normal mortar;

FIG. 15 is a photograph of Mix 5 without fibers that has been machined and tapped;

FIG. 16 is a representation of dimensions for SENB specimens (mm);

FIG. 17 is a graph of fracture toughness with fiber volume fraction;

FIG. 18 is a representation of an experimental set up for third point bending (mm);

FIG. 19 is a graph of flexural stress versus volume fiber fraction;

FIG. 20 is a graph of a comparison of fracture toughness;

FIG. 21 is a graph of impact energy as a function of fiber percentage;

FIG. 22 is a graph of PVB mortar load as a function of deflection; and

FIG. 23 is a graph of load as a function of deflection for a lightweight silica aggregate mortar.

### DETAILED DESCRIPTION OF THE INVENTION

A new generation of composites fabricated by placing a low modulus, lightweight matrix over multiple layers of a relatively stiff reinforcement is a goal in the art of making cementitious materials. The ability of such a matrix to store and release energy depends upon a complex interaction between the shape, modal response, and the forcing function applied to drive the structure.

Although the designs are based on the strength, stiffness, and position of the materials in the composite section, matrix design is critical to the structural performance, since the overall design strategy relies on the large difference in stiffness between the constituents in the composite section to drive the internal stress from the matrix to the reinforcement. Polymeric matrices are more flexible than the conventional cementitious materials currently used to construct most advanced composite materials. However, they still have their drawbacks.

It is desirable to produce thin, lightweight, and structurally efficient panels capable of resisting stresses produced by reverse loadings such as bending, torsion, and tension/compression. Studies have showed that a very efficient composite structure could be fabricated by placing a flexible polymer-enhanced cementitious matrix having a relatively low elastic modulus over two layers of a rigid steel wire mesh having a relatively high elastic modulus. It is desirable to produce a material that will combine the properties of compressive strength with relatively high tensile strength and low modulus of elasticity as well as good bond strength between the matrix and the reinforcement.

Graphite-reinforced composites have been developed in an effort to achieve this goal. Multi-layered composite beams have also been developed.

Previous studies involving interactions between the aggregate and matrix in cementitious composites show that the interfacial transition zone (ITZ), which is characterized by the prevalence of calcium hydroxide and higher porosity, is the weakest region in a concrete structure. Interactions in this zone drive many important macroscopic properties, such as strength, permeability, and durability.

Researchers studying the microstructure of the ITZ and the hydration progression into it, for example, have confirmed a wall effect. They note that ions have a tendency to flow slightly faster near the wall because of the decreased permeability in this zone. As a result, the space around the aggregates is less effectively filled by hydration products. At the same time, there is greater tendency for calcium hydroxide [CH(Ca(OH)₂)] and ettringite to develop in this space.

Methods have been studied to improve the aggregate/matrix bonding in the ITZ, such as reducing the size of the aggregates, using basalt and quartzite as aggregates, or replacing the cement with ultrafine additions of constituents, such as silica fume and metakaolin. However, these methods are limited in scope, since they do not significantly alter the nature of the interaction between aggregate and matrix.

Moreover, in addition to interactions within the aggregate/matrix interface, fiber/matrix debonding may occur due to mechanisms such as shear type deformation and fiber sliding. Steel and glass fibers are typically added to reinforce the matrix because of their high tensile strength. However, the bond strength between these traditional materials and the matrix is limited.

The methods for enhancing the strength at an interface and the philosophy for using the traditional materials described above originated prior to the development of nanotechnology and supramolecular chemistry. These processes can be used to create new materials, devices, and systems at the molecular level by adjusting phenomena associated with atomic and molecular interactions that strongly influence macroscopic material properties. It is desirable, therefore, to develop materials having the potential to form strong interactions at the molecular level to produce novel nanocomposites with enhanced properties. Conventionally, the reinforcement of concrete consisted of a bidirectional mesh fabricated from either steel or graphite. However, when fabricating such a material some of the desired properties had to be sacrificed to enhance other properties. The objective is to therefore enhance all of the desired properties mentioned above without sacrificing any one of them.

It has been determined that the classical laminated plate theory developed for composite materials may be applied to quantify the dynamic behavior of highly compliant composite structures made from cementitious materials. Embodiments of the present invention provide for compositions and methods to improve the stress strain characteristics of cementitious mortars and concretes which do not destructively, suddenly and disastrously and explosively fail under load as do regular and high performance mortars.

Embodiments of the present invention provide a cementitious matrix including interfacial bonds between a poly(vinyl butyral) (PVB)/cement aggregate and reinforcement materials.

A preferred reinforcement material is poly(vinyl alcohol) (PVA).

Embodiments of the present invention also provide for a method of storing energy by applying the cementitious matrix to a surface, applying energy to the surface, and storing energy in the cementitious matrix. This prevents blast fragmentation by applying the cementitious matrix to a surface, absorbing energy from a blast in the cementitious matrix, and preventing blast fragmentation from the blast.

Embodiments of the present invention provide for a method of radiation shielding especially for alpha and beta particles, by applying the cementitious matrix to a surface, absorbing radiation in the cementitious matrix, and shielding the surface from radiation.

Embodiments of the present invention provide a method for producing, at room temperature or in the field, ductile materials with high surface hardness, modulus and compression strengths compared to most thermoplastics, which can be formed into multiple objects such as countertops, building sheathing, bathtubs, boats, and the like, which additionally can be easily machined, sanded, polished and tapped. Building materials such as roof tiles, floor and wall tiles and window frames can be made of this material. Whole floors for buildings or rooms can be poured in place. The material may be used to fill expansion contraction joints in highways and bridges.

Compositions of the present invention may be used to produce sensors to determine the structural stress, integrity and life time of objects made out of cementitious materials such as civil engineering structures including bridges, airport runways and highways and buildings or even railroad ties. Strain gauges can be added to the material to produce an integral measurement device.

Compositions of the present invention absorb microwaves well and may be used as a microwave shield. Since the material has a higher heat capacity than regular concrete, it can be used as a heat sink or an electrical potting material.

Compositions of the present invention counter conventional known characteristics of standard concrete mixtures related to the relationship between fractal roughness and material toughness. It is commonly accepted that the higher the fractal dimensions for fractal roughness the higher the material toughness. In other words, concretes having large aggregates are tougher than those with smaller aggregates. However, embodiments of the present invention provide formulations and methods for increasing fracture toughness without increasing the aggregate size.

Embodiments of the present invention provide a cementitious matrix that produces strong interfacial bonds between aggregate and reinforcement materials in order to store energy. The aggregate is poly(vinyl butyral) (PVB)/cement and the preferred reinforcement material is poly(vinyl alcohol) (PVA).

Both poly(vinyl butyral) (PVB) and poly(vinyl alcohol) (PVA) contain hydroxyl groups that have the potential to form a hydrogen bond between molecules, or within different parts of a single molecule. This unique feature provides remarkable changes in the surface bond strength, not only between the aggregate and the matrix, but also between the fiber reinforcement and the matrix. Additionally, the ether oxygen functional groups act as a weak base and can interact with Lewis acids and electropositive materials such as C-S-H.

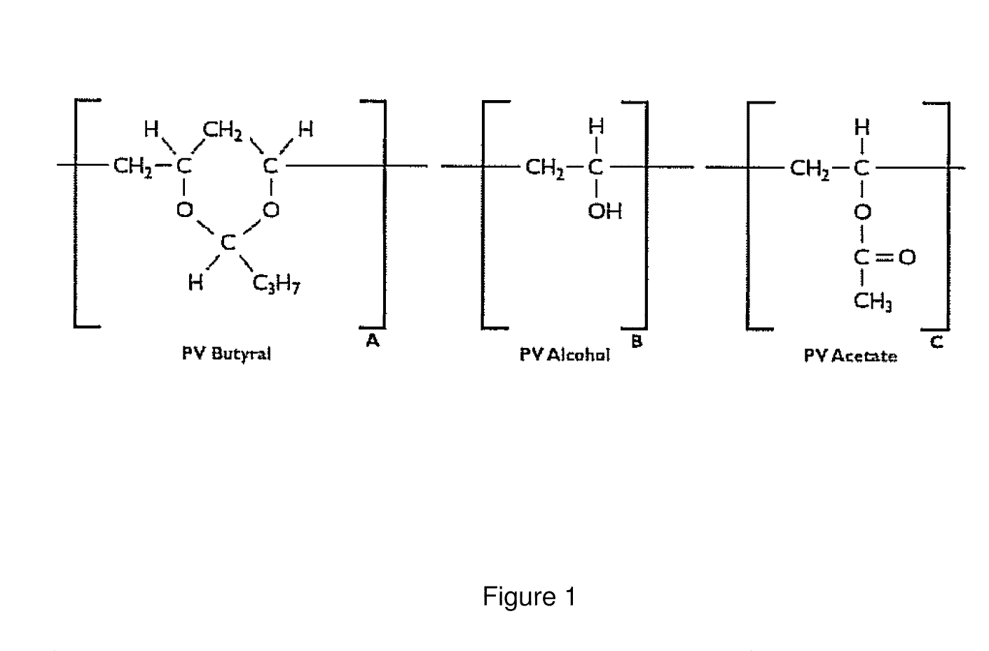

PVB is a member of the class of poly(vinyl acetal) resins. It is derived by condensing poly(vinyl alcohol) (PVA) with butyraldehyde in the presence of a strong acid. PVA reacts with the aldehyde to form six-membered rings primarily between adjacent intramolecular hydroxyl groups, leading to the structure shown in FIG. 1. A variety of suppliers provide PVB. Some of these include DuPont (“Butacite”), Solutia (“Saflex”), Kuraray Europe GmbH “(Trosifol” and “Mowital”), Sekisui Corp., Solutia, Inc. (“Butvar”) B-79 and Wacker.

PVB is commercially prepared by a well-known reaction between aldehydes and alcohols. However, the resulting polymer is actually a terpolymer of PVB, polyvinyl alcohol (PVA), and polyvinyl acetate because of incomplete conversion.

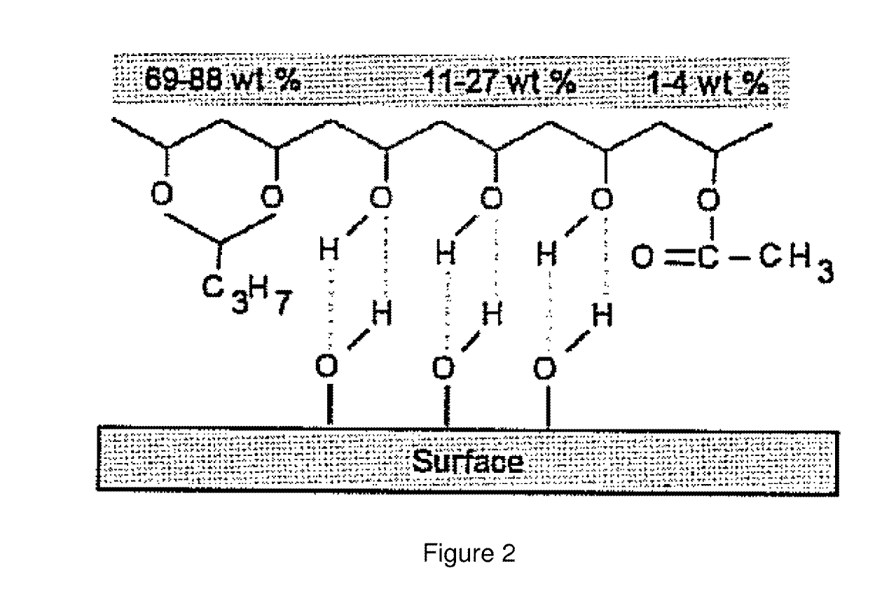

The presence of hydroxyl groups in the polymer molecule not only enables good wetting of most substrates, but also furnishes a reactive site for chemical combination with thermosetting resins. This is attributed to the hydroxyl groups in the PVB polymer that provide electrostatic attractive and hydrogen bonding interactions with other substances. PVB has a mixed hydrophobic hydrophilic nature, and thus the aggregate surface availability depends on the nature of the solvent it is within. PVB is essentially insoluble in water in most forms and is usually supplied commercially as a white powder with aggregate size less than 2 mm. The hydrophilic chemical interaction is illustrated in FIG. 2. PVB can also be used in the present invention as a sizing agent to coat silicon dioxide or other hard aggregates to provide a plurality of features described herein. PVB is essentially insoluble in water.

PVA is obtained from poly(vinyl acetate), which is readily hydrolyzed by treating an alcoholic solution with an aqueous acid or alkali. PVA is a white powder with a specific gravity in the range of 1.2-1.3 and a glass transition temperature of around 80 degrees C.

There are three main reasons for considering PVA fiber as a reinforcing material; namely, 1) the mechanical properties of the fiber, and 2) the ability of the fiber to bond well with a cementitious matrix and 3) the previously unknown ability to bind to the PVB aggregate in a cementitious matrix which has been determined experimentally. However, other fibers may be utilized, such as plastic resin fibers of uniform or multiple plastic resin types and metal, ceramic or glass fibers. The fiber has a high tensile strength of 1.23×10³ MPa, a high elastic modulus of 2.95×10⁴ MPa, and a low specific weight of 1.3.

The hydrophilic nature of PVA fibers cause them to bond well with the cementitious matrix. The formation of this microstructure is attributed to the effect that PVA has on the nucleation of CH and C-S-H at the fiber surface and on the presence of polymer around the fibers.

The cementitious matrix of the present invention is unlike standard hard aggregate concrete in that it can be easily machined and it behaves similar to polymethylmethacrylate (acrylic plastic). The cementitious matrix can be sawed, drilled, tapped, machined, and polished according to methods known in the art. When applied to a surface, the cementitious matrix provides a shiny and easily polished surface.

Various other materials can be added to the cementitious matrix. For example, cerium oxide can be added such as cerium (IV) oxide nanoparticles in amounts of from about 0.05% to about 1%, by weight of the total weight of the cementitious matrix. Colorants such as standard dyes can also be added in small quantities to provide better coloring properties. Latex can be added in an amount of from about 40% to about 50%, by weight of the total weight of the cementitious matrix, in order to provide more flexible Portland/PVB compositions such as styrene butadiene latex or a PVAC, PVOH, EVAC, or EVOH latex, or aqueous latex.

Steel bars or fibers can be added to the PVB for reinforcement in order to reduce corrosion and rust. Glass, aramid, and carbon fiber, roving, or fabric can be used both internally and externally in the cementitious matrix as reinforcement. Normal weight or lightweight sand can be added to the matrix in order to improve the properties.

When describing the proportions of components for the cementitious matrix, they are described as a percentage of the total weight of the cementitious matrix after the addition of water or in the case of the pozzolans, as a percentage relative to just the cement by weight.

The following are physical mix designs of the matrix. The matrix can include pozzolan in an amount of up to 10%, by weight of the total weight of the cementitious matrix. Preferably, the cement used in the matrix is Portland cement, as defined in ASTM 150. Other cements can be used, such as blends defined in ASTM C 595 (e.g., a Portland-pozzolan blend). A minimum of 1% PVB is mixed with the cement of the total weight percentage of PVB to cement. Preferably, a range of 1% to about 55%, by weight PVB to cement is used. Most preferably, the range of PVB to cement is about 10% to 45%, by weight. The density of the cement is preferably between 0.9 and 2 grams/mL (0.9 and 2 kg/L). A pozzolanic material such as metakaolin may be added at from 0% to about 5% of the cement, by weight. Silica fume can also be added in amounts less than 10% of the cement by weight. PVA fiber is added from about 0.1% to about 3% of the total matrix by weight. Preferably, the range of PVA fiber added is from about 0.5% to about 1.5%. Most preferably, PVA about 0.9% cementitious weight is added. A superplasticizer, such as polycarboxylate, can be added from 0% to 3% of the total matrix by weight.

Preferably, water is present at about 25% or greater of the cement and pozzolans by weight. To avoid using too much water, which can decrease the strength of the matrix, it can be advantageous to use more vigorous mixers than traditional cement mixing equipment. The added energy of the mixers can allow a stiffer, more complete mixture.

When the cementitious matrix is used as a coating, it can be any suitable depth. Preferably, when a military vehicle is coated, the coating is deep enough to protect the occupants but not so deep as to slow down the maneuverability of the vehicle.

Essentially, the cementitious matrix stores energy when energy is applied to the matrix. The cementitious matrix is a highly effective energy absorber, as detailed in the example below. This energy storage is useful for a variety of applications described below.

The present invention provides for a method of protecting a structure from blast fragmentation or penetration by coating the structure, or applying a sheathing to the structure with the cementitious matrix described herein. Preferably, the structure protected is a military vehicle or a building or an ammunition storage facility. For example, normally when a projectile is shot at a tank or a tree limb is blown at 100 mph at a building during a hurricane, or a artillery round or a grenade explodes inside an ammunition storage facility, it enters the structure and those in and around the structure are severely injured or killed. The cementitious matrix absorbs energy from a blast from any type of projectile, and this energy is then stored in the cementitious matrix instead of causing the wall to shatter. Examples of this energy storage are further described below.

The cementitious matrix can also be used to shield radiation. In this method, radiation is incident on a surface of the cementitious matrix and is absorbed by the cementitious matrix. The cementitious matrix can be applied to any surface in need of radiation shielding.

The invention is further described in detail by reference to the following experimental examples. These examples are provided for the purpose of illustration only, and are not intended to be limiting unless otherwise specified. Thus, the present invention should in no way be construed as being limited to the following examples, but rather be construed to encompass any and all variations which become evident as a result of the teaching provided herein.

### Example 1

A baseline mix (Mix No. M1) is shown in Table 1 to provide the basic criteria for materials used in combination with high tensile interlayers: (high strength, low density, and low modulus). Then, three other mixes were placed (M2, M3, and M4) with the same water to cement ratio (w/c) and progressively higher PVA fiber volume fractions, Vr (0.3%, 0.6%, and 0.9%, respectively). Specimens were prepared and tests conducted to study how different fiber volume fractions affected the compressive strength, flexural strength, ductility, fracture toughness, and impact resistance. All of the results presented later in the section labeled “Experimental Testing” reflect average values taken from three specimens.

TABLE 1

| | | | | | | | | Water | PVA |
|---|---|---|---|---|---|---|---|---|---|
| | | | | | | M | PVA | to | Volume |
| Mix | Cement | Metakaolin | Water | SIKA | B 79 | B75H | fiber | Cement | Fraction |
| No. | (grams) | (grams) | (grams) | (grams) | (grams) | (grams) | (grams) | Ratio | V_{f} |
| M1 | 833.3 | 79.4 | 363.5 | 11.9 | 182.5 | 119.0 | 0 | 0.4 | 0 |
| M2 | 833.3 | 79.4 | 363.5 | 11.9 | 182.5 | 119.0 | 4.2 | 0.4 | 0.3 |
| M3 | 833.3 | 79.4 | 363.5 | 11.9 | 182.5 | 119.0 | 8.3 | 0.4 | 0.6 |
| M4 | 833.3 | 79.4 | 363.5 | 11.9 | 182.5 | 119.0 | 12.5 | 0.4 | 0.9 |

Referring to Table 1, from left to right: the cement was ASTM Type 1 normal Portland cement conforming to ASTM C150; Metakaolin (MK) conformed to ASTM C618 [39]; and, the Sika ViscoCrete 2100 superplasticizer conformed to ASTM C494.

The PVB added to each mix consisted of a combination of Butvar B-79 and Mowital B75H. Butvar B-79 is manufactured by Solutia, Inc.; Mowital is produced by Kuraray Specialties Europe (KSE). Table 2 highlights selected properties of these PVB products. PVB has a range of particles sizes, but in all cases 90 percent of the particles were less than 1 mm in size.

TABLE 2

| Property | Units | Designation | Value |
|---|---|---|---|
| PVOH* content | % | B-79 | 11.5-13.5 |
| | | M-B75H | 11-27 |
| Specific gravity | — | B-79 | 1.083 |
| | | M-B75H | 1.1 |
| Tensile yield strength | MPa | B-79 | 40-47 |
| | | M-B75H | |
| Elastic modulus | MPa × 10³ | B-79 | 1.93-2.0 |
| | | M-B75H | |
| Impact strength | J m⁻¹ | Izod notched | 42.7 |
| | | (1.25 cm × 1.25 cm); | |
| | | B-79 | |
| | | M-B75H | — |
| Glass transition | Degrees C. | B-79 | 62-72 |
| temperature | | M-B75H | 73 |

*PVOH is the PVA residue in the PVB polymer

The PVA fibers used were manufactured by Kuraray Co. Ltd. of Japan. They are classified by the manufacturer as RECS15 and have the properties listed in Table 3.

TABLE 3

| | | | Cut | Tensile | | | |
|---|---|---|---|---|---|---|---|
| Fiber | Diameter | Thickness | Length | Strength | Elongation | Modulus | Specific |
| Type | (mm) | (dtex) | (mm) | (N/mm²) | (%) | (kN/mm²) | Gravity |
| RECS15 | 0.04 | 15 | 8 | 1600 | 7 | 40 | 1.3 |

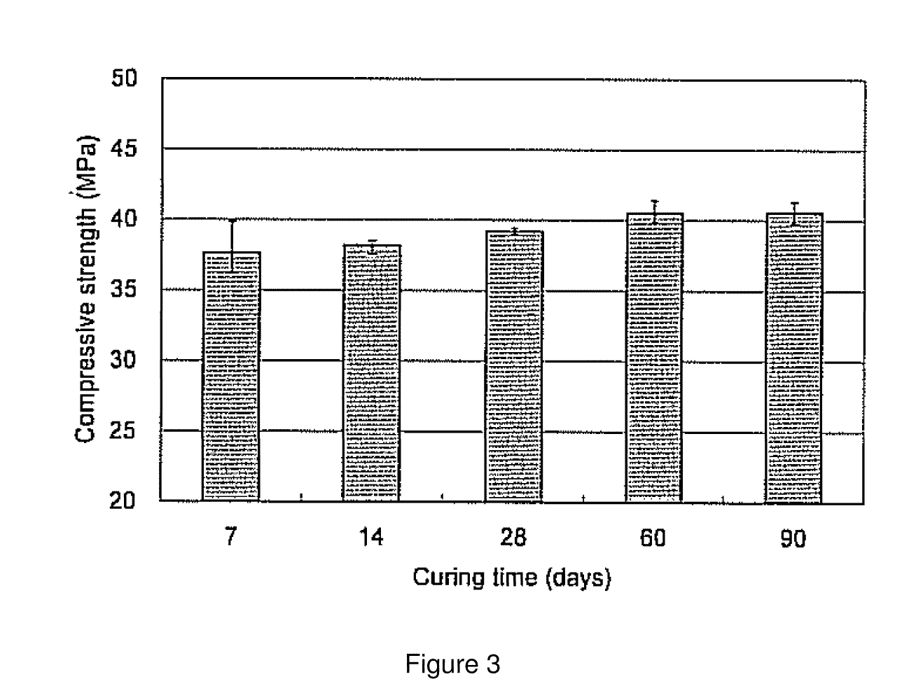

Compressive strength was measured by testing 50 mm diameter 100 mm long (2 in. diameter×4 in. long) cylinders at a constant loading rate of 20 MPa/min (2901 psi/min) following ASTM C39. FIG. 3 shows a plot of the compressive strength of the baseline mix (M1) with time. It is observed that the strength increases slightly up to 60 days, after which the change is insignificant.

The data listed in Table 4 shows that specimens without PVA fibers (M1) have an average compressive strength of 37.7 MPa (5461.4 psi) based on a 7 day cure. By comparison, the specimens placed with PVA fibers at a fiber volume fraction equal to 0.6% (M3), have an average compressive strength of 34.2 MPa (4896.2 psi) over the same period. It can be concluded that the addition of the fibers reduces the compressive strength by about ten percent.

TABLE 4

| | | | Compressive | |
|---|---|---|---|---|
| | | V_{f} | Strength | Density |
| Mix No. | No. Specimens | (%) | (MPa) | (kg/m³) |
| M1 | 3 | 0 | 37.7 +/− 1.56 | 1548.2 +/− 3.90 |
| M3 | 3 | 0.6 | 34.2 +/− 0.14 | 1540.0 +/− 7.30 |

This slight reduction is attributed to the fact that the free fibers are randomly oriented thereby reducing their ability to resist compressive loads. They take up space and this reduces the effective bearing surface over which the applied load is distributed. Note that the average density of the specimens with PVA fibers was 1540.0 kg/m³ (96.1 lb/ft³), slightly lower than that of the specimens without them.

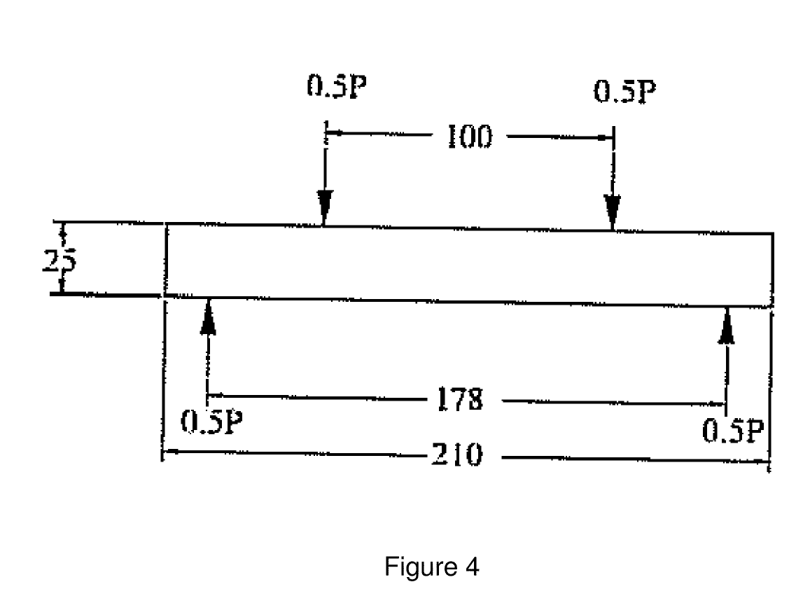

As illustrated in FIG. 4, the flexural strength was measured, in accordance with ASTM C1609, by placing test specimens in third point bending. The specimens, which measured 70×25×210 mm (2.75×8.25 in.) were loaded at a rate of 667 N/min (150 lb/min), corresponding to a stress increase at the bottom surface (tensile side of the beam) of 1.72 MPa/min (250 psi/min).

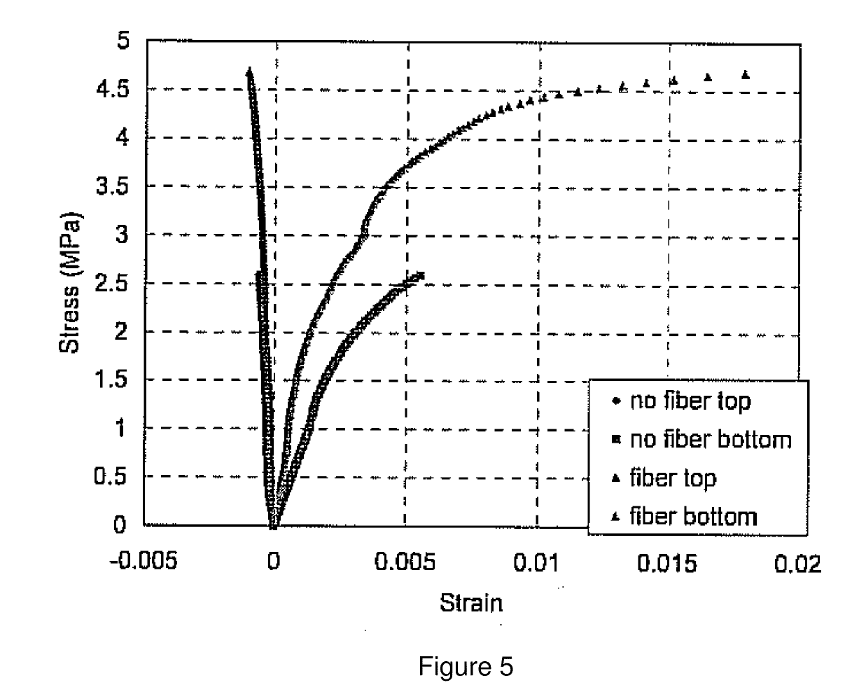

FIG. 5 shows the flexural stress-strain plots for beams without (M1) and with fibers included at a fiber volume equal to 0.6% (M3). Strain measurements were made on the top (compressive side of the beam) and bottom surfaces using strain gages.

Referring to FIG. 5, specimens without fibers reached an average ultimate stress of about 2.59 MPa (375 psi), and the average strains at failure were −0.0006 and 0.0055 at the top and bottom, respectively. Specimens with fibers reached a higher average ultimate stress of 4.69 MPa (680 psi); the average strains at failure were −0.001 and 0.018 at the top and bottom of the beam, respectively. From these results, it can be concluded that the addition of fibers significantly improves the flexural strength. Since the beams with fibers were much stronger, and the compressive strength of a fiber-free matrix was observed to decrease when fibers were added, it can be inferred that the addition of fibers significantly increases the tensile strength of the matrix.

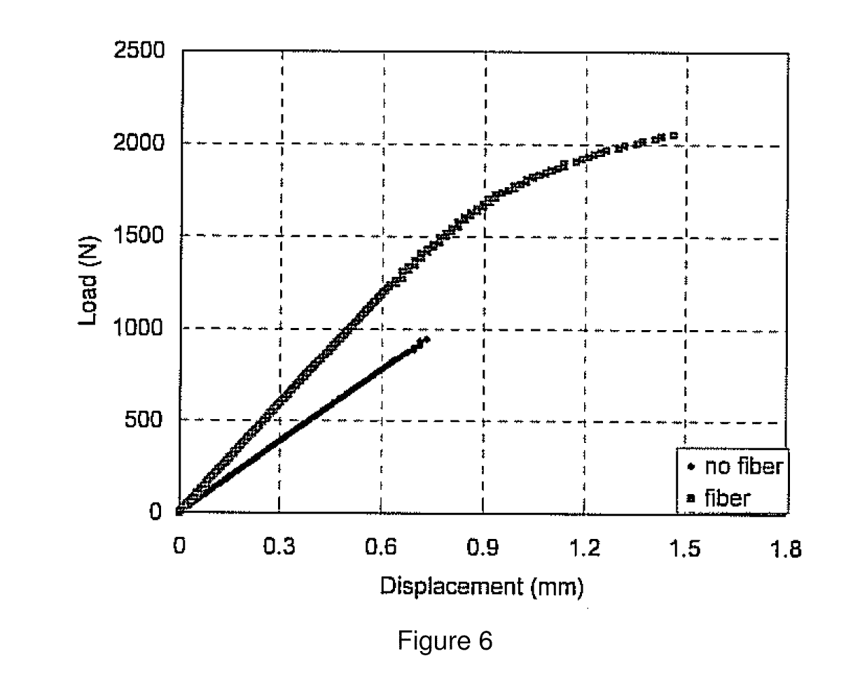

Toughness (ductility) is generally defined as the energy adsorption capacity and this parameter is calculated based on the area under a load-displacement curve. FIG. 6 shows the load-displacement curves generated for the bending specimens placed with the two mixes described above. Referring to FIG. 4, displacements were measured at the center of the beam relative to the upper supports. Table 5 contains relevant data.

The flexural toughness was computed by integrating the area under the curves up to the point of collapse. The toughness of the mix with no fibers was around 350 N-mm while that of the mix with fibers was about 1883 N-mm, thereby demonstrating that the addition of fibers markedly improves ductility (by more than 400%).

TABLE 5

| | | | | | Flexural |
|---|---|---|---|---|---|
| Mix- | No. | V_{f} | Load | Displacement | Toughness |
| ture | Specimens | (%) | (N) | (mm) | (N-mm) |
| M1 | 3 | 0 | 932 +/− 16 | 0.75 +/− 0.1 | 350 +/− 0.8 |
| M3 | 3 | 0.6 | 2093 +/− 105 | 1.64 +/− 0.1 | 1883 +/− 5.3 |

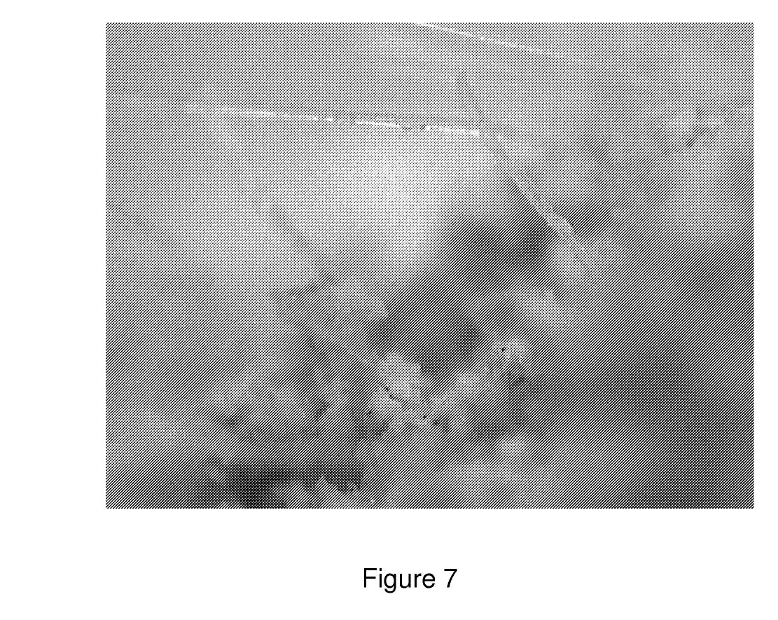

The improvement in flexural strength is attributed to the reinforcing effect created by the PVA fibers. FIG. 7 shows a photograph of the fracture surface in a specimen that contained fibers. Many of the fibers remained intact, indicating that they pulled away from the matrix, as opposed to rupturing along their length. Importantly PVB particles were found to be attached to the PVA fiber even after pullout, suggesting that within the cementitious matrix, PVB assembles with the PVA to form a hybrid fiber aggregate unit.

### Development of Fracture Toughness Model

The resistance to fracture of a material is known as its fracture toughness. The latter can be considered as a stress-based estimation derived from a function of the applied force and a specimen's geometry. Linear elastic fracture mechanics (LEFM) may be employed but this method is valid only as long as nonlinear material deformation is confined to a small region surrounding the crack tip.

There are other methods that can be used to estimate the fracture toughness, such as crack-tip-opening displacement (CTOD) and the J-integral formulation. These methods are used to assess the elastic-plastic behavior of materials such as metals and alloys by considering crack-tip plasticity.

But, because there is almost no plasticity developed in a brittle material such as concrete, a stress-based estimation of fracture toughness is developed herein. The formulation is based on a well known concept called the “rule of mixtures”. Although many models have been developed based on this concept to calculate the tensile stress of fiber reinforced composites little attention has been paid to models involving fracture toughness.

The ultimate tensile strength of a fiber reinforced composite is a function of the fiber, the interface between the fiber and the matrix, and the matrix characteristics. The following equation was derived based on a micromechanical model involving the bridging mechanism of randomly oriented short straight fibers:

$${σ}_{t} = \frac{1}{2} {V}_{f} g τ ( \frac{{L}_{f}}{{d}_{f}} ) \qquad ( 1 )$$

where V_{f}, L_{f}, and d_{f} are the fiber volume fraction, length of fiber, and the diameter of the fiber, respectively. τ is the fiber/matrix frictional bond strength; and, g is a set of interface parameters developed for different fiber types as follows:

$$g = \frac{2}{( 4 + {f}^{2} )} ( 1 + {e}^{f π / 2} ) \qquad ( 2 )$$

In Eq. 2, f is a snubbing coefficient that must be determined experimentally for a given fiber/matrix system.
The fiber volume fraction can be calculated from the following equation:

$${V}_{f} = \frac{{ρ}_{m} {W}_{f}}{{ρ}_{f} {W}_{m} + {ρ}_{m} {W}_{f}} \qquad ( 3 )$$

where W_{f} is the weight of fibers; Wₘ is the weight of the matrix; ρₜ is the density of the fibers; and ρₘ is the density of the matrix.

Optimization of the interfacial bond strength can only be achieved when the fiber has a length large enough to provide resistance to fiber pull-out and a sufficiently high fiber modulus of rupture to avoid fiber fracture. If the fiber length used in the mix design is less than a critical length, fiber pull-out will occur. If the fiber length is longer than the critical fiber length, then fiber rupture will be the primary mode of failure.

At low strains, where the fibers and the matrix behave elastically, the composite modulus, E, is determined by a modulus balance which weights the fiber modulus, E_{f}, and matrix modulus, Eₘ, by their corresponding volume fractions V_{f} and Vₘ, respectively. Mathematically,

E=E_{f}V_{f}+EₘVₘ (4)

Equation 4 is the well known rule-of-mixtures (ROM) for the tensile modulus of a composite material and is applicable when the reinforcing fibers are both continuous and well aligned with stress applied along the direction of the fibers.

Equation 4 may be reformulated to reflect the fact that the matrix and fiber develop the same strain, ε, as follows:

σ=σ_{f}V_{f}+σₘVₘ (5)

Keeping in mind that:

Vₘ=1−V_{f} (6)

Eq. (5) becomes:

σ=σ_{f}V_{f}+σₘ(1−V_{f}) (7)

The matrix fracture toughness of plain concrete can be calculated using ASTM E 399, Standard Test Method for Linear-Elastic Plane-Strain Fracture Toughness K1c of Metallic Materials, as follows:

$${K}_{m} = \frac{PS}{{BW}^{1.5}} f ( \frac{a}{W} ) \qquad ( 8 )$$

where, P is the load applied to a single edge notch bending (SENB) specimen; S is the distance between the supports; B is the specimen width; W is the specimen thickness; a is the notch length; and, f(a/W) is a shape function calculated as follows:

$$f ( \frac{a}{W} ) = \frac{3 \frac{S}{W} \sqrt{\frac{a}{W}}}{2 ( 1 + 2 \frac{a}{W} ) {( 1 - \frac{a}{W} )}^{1.5}} \\ \{ 1.99 - \frac{a}{W} ( 1 - \frac{a}{W} ) [ \begin{matrix}2.15 - 3.93 ( \frac{a}{W} ) + \\ 2.7 {( \frac{a}{W} )}^{2}\end{matrix} ] \} \qquad ( 9 )$$

The shape function is developed based on a finite element analysis; solutions of this type are typically fit to a polynomial expression.

In prior work done on PVB/PVA materials, observations made in failed specimens revealed that many of the fibers remained intact; indicating that they pulled away from the matrix. Thus, it can be construed that failure occurs as a result of fiber pull-out, where the fiber length used in the mix design is less than the critical fiber length.

Specifically, at the beginning of the loading process the matrix and fiber work together to resist the tensile stress. In this case, the stress is transferred from the matrix to the fiber via the fiber/matrix interface. But when loads are increased to the point at which the matrix begins to crack, the stress is transferred to the fibers alone. Since the fibers have a higher tensile strength than the friction bond strength at the interface, they pull out of the matrix and failure occurs.

The tensile stress of the composite at mid-span in the SENB is given by Eq. 7 where the term (σ_{f}V_{f}) represents the contribution made by the fibers. Assuming that pull-out dominates failure, this contribution may be described by Eq. 1. Making the appropriate substitution:

$$σ = \frac{1}{2} {V}_{f} g τ ( \frac{{L}_{f}}{{d}_{f}} ) + {σ}_{m} ( 1 - {V}_{f} ) \qquad ( 10 )$$

Eq. 10, σ is the tensile stress of the composite which can be calculated according to beam theory as:

$$σ = \frac{M \cdot c}{I} \qquad ( 11 )$$

where c is the distance from the neutral axis to the extreme tensile fiber. Referring to the test and parameters described in conjunction with Eq. 8,

$$c = \frac{W - a}{2} \qquad ( 12 )$$

Consequently, Eq. [11] can be written as:

$$σ = \frac{M \cdot c}{I} = \frac{M \cdot \frac{W - a}{2}}{I} = \frac{PS ( W - a )}{8 I} \qquad ( 13 )$$

where P is the force at mid-span, S is the length of the free span, W is the height of the beam, and I is the centroidal moment of inertia parallel to the axis about which the moment is applied. The maximum tensile stress that the matrix can sustain is equal to:

$${σ}_{m} = \frac{{P}_{0} S ( W - a )}{8 I} \qquad ( 14 )$$

where P₀ is the failure load of a specimen placed without fiber.
Substituting Eqs. 13 and 14 into Eq. 10 yields:

$$\frac{PS ( W - a )}{8 I} = \frac{{P}_{0} S ( W - a )}{8 I} ( 1 - {V}_{f} ) + \frac{1}{2} {V}_{f} g τ ( \frac{{L}_{f}}{{d}_{f}} ) \qquad ( 15 )$$

Thus, P can be expressed as,

$$P = \frac{8 I}{( W - a ) S} [ \frac{{P}_{0} S ( W - a )}{8 I} ( 1 - {V}_{f} ) + \frac{1}{2} {V}_{f} g τ ( \frac{{L}_{f}}{{d}_{f}} ) ] \qquad ( 16 )$$

where the centroidal moment of inertia is calculated as follows:

$$I = \frac{1}{12} {B ( W - a )}^{3} \qquad ( 17 )$$

Substituting Eqs. 16 and 17 into Eq. 8 leads to the following expression for the fracture toughness:

$${K}_{Ic} = \frac{2 {( W - a )}^{2}}{3 {SW}^{0.5}} [ \begin{matrix}\frac{3 {P}_{0} S}{2 {B ( W - a )}^{2}} ( 1 - {V}_{f} ) + \\ \frac{1}{2} {V}_{f} g τ ( \frac{{L}_{f}}{{d}_{f}} )\end{matrix} ] f ( a / W ) \qquad ( 18 )$$

where f(a/W) is the shape function expressed in Eq. 9.

### Experiments

Fracture toughness tests were performed on single edge notch bending (SENB) specimens following ASTM E399. The test specimens measured 23×46×203 mm (0.9×1.8×8.0 in.) They had a notch height to beam height (a/W) ratio equal to 0.5 and a free span to beam height ratio of 4.0. Specimens were tested in three-point bending, at a loading rate of 33 MPa-m^{0.5}/min (30 ksi-in^{0.5}/min).

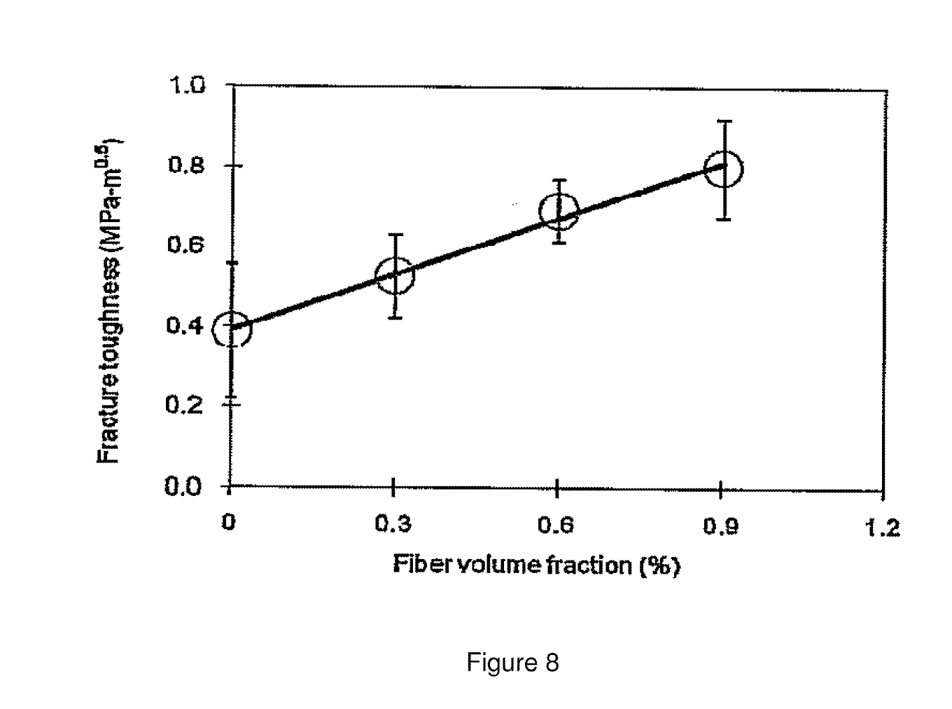

Table 6 and FIG. 8 show data and a plot, respectively, of the fracture toughness obtained for specimens having progressively higher fiber volume fractions. It is evident that the fracture toughness increases linearly with the fiber volume fraction, resulting in improvements ranging from 37% to 108%. Visual inspection of the fracture surfaces indicated behavior similar to that observed during the flexural test where the fibers pulled away from the matrix as opposed to rupturing along their length during failure.

TABLE 6

| | | V_{f} | Fracture Toughness |
|---|---|---|---|
| Mix No. | No. Specimens | (%) | (MPa-m^{0.5}) |
| M1 | 3 | 0 | 0.389 +/− 0.021 |
| M2 | 3 | 0.3 | 0.528 +/− 0.061 |
| M3 | 3 | 0.6 | 0.691 +/− 0.077 |
| M4 | 3 | 0.9 | 0.800 +/− 0.134 |

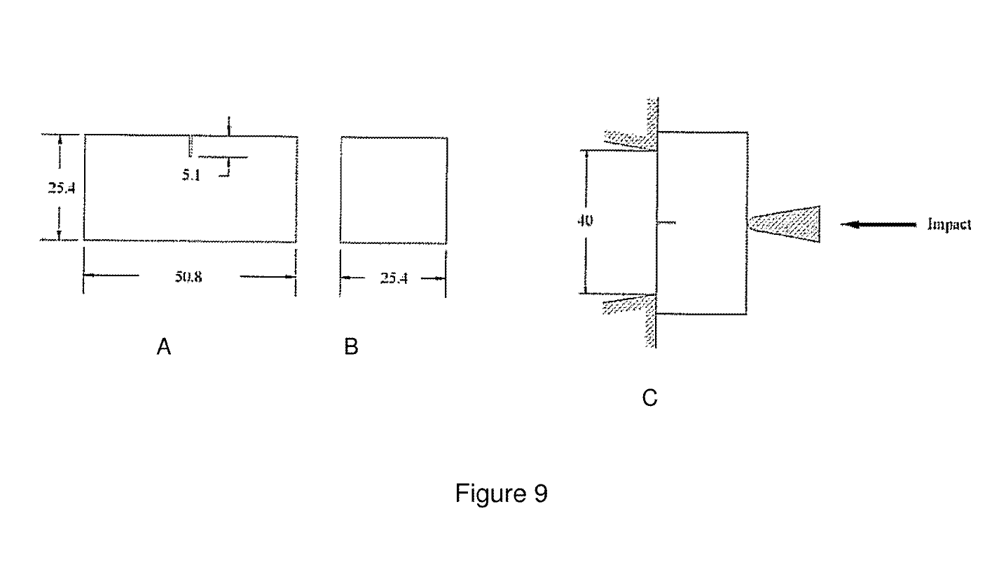

Charpy V-notch tests were conducted following ASTM E23. FIGS. 9A-9C includes the dimensions of the specimens tested using a Tinius Olsen “Change-O-Matic” impact testing machine.

After positioning the specimen, the pendulum is released from a height, y₁, and swings through the specimen to a height, y₂. Assuming negligible friction and aerodynamic drag, the energy absorbed by the specimen is equal to the height difference times the weight of the pendulum.

TABLE 7

| | | V_{f} | Impact energy |
|---|---|---|---|
| Mix No. | No. Specimens | (%) | (J-m⁻¹) |
| M1 | 3 | 0 | 214.6 +/− 4.9 |
| M2 | 3 | 0.3 | 231.8 +/− 10.0 |
| M3 | 3 | 0.6 | 261.1 +/− 13.2 |
| M4 | 3 | 0.9 | 458.1 +/− 49.2 |

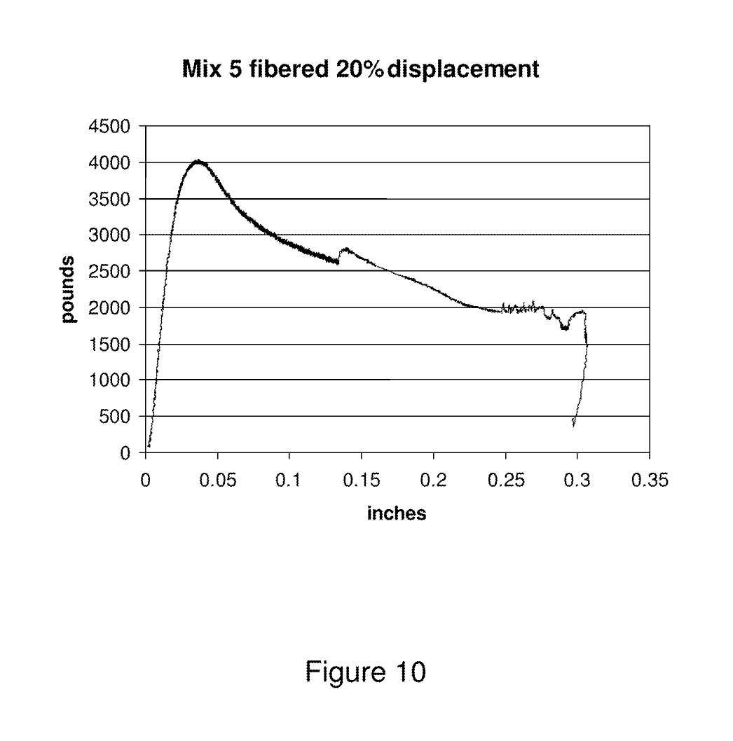

Table 7 and FIG. 10 show data and a plot, respectively, of the average impact energy obtained for specimens having progressively higher fiber volume fractions. It is evident that the impact energy dramatically increases when the fiber volume fraction reaches 0.9%.

### Example 2

The following compositions of mixes of the cementitious matrix listed in Table 8 were made. In addition to the components listed, Mix 7 contained 100 mg of cerium (iv) oxide nanoparticles less than 100 nanometers in size and 50 g of latex acrylic.

TABLE 8

| | | | | | | | PVA | |
|---|---|---|---|---|---|---|---|---|
| Mix | Cement | Pozzolan | Water | SIKA | PVB | Latex | fiber | Wollostonite |
| No. | (grams) | (grams) | (grams) | (grams) | (grams) | (grams) | (grams) | (grams) |
| Mix 1 | 200 | 20 | 15 | 5 | 85 | 110 | | 2 |
| Mix 2 | 200 | 20 | 15 | 5 | 85 | 110 | | 2 |
| Mix 3 | 200 | 20 | 15 | 5 | 85 | 110 | | 2 |
| Mix 4 | 60 | 6 | 24 | 0.7 | 15 | | 0.5 | |
| Mix 5 | 105 | 10 | | 3 | 48 | 50 | 1 | |
| Mix 7 | 105 | 10 | | 3 | 40 | | | |

Table 9 shows some of the physical properties of the mixes of Table 8.

TABLE 9

| | Compression | Density | | | | Compression |
|---|---|---|---|---|---|---|
| | strength | measured | Diameter | Height | Weight | strength stress, psi/ |
| Mix name | stress, f psi | Gms/ml | mm | mm | gms | density |
| Mix 1 | 1200 | 0.94 | 30 | 38.608 | 25 | 1276.60 |
| Mix 2 | 1200 | 0.92 | 30 | 42.418 | 26 | 1304.35 |
| Mix 3 | 1600 | 0.98 | 30 | 40.894 | 26.35 | 1632.65 |
| Mix 4 | 12035 | 1.88 | 31.00 | 44.00 | 62.89 | 6401.60 |
| Mix 5 | 4100 | 1.42 | 30.00 | 40.64 | 40.23 | 2890.86 |
| Mix 7 | 5200 | 1.42 | 30.00 | 40.89 | 41.25 | 3661.97 |

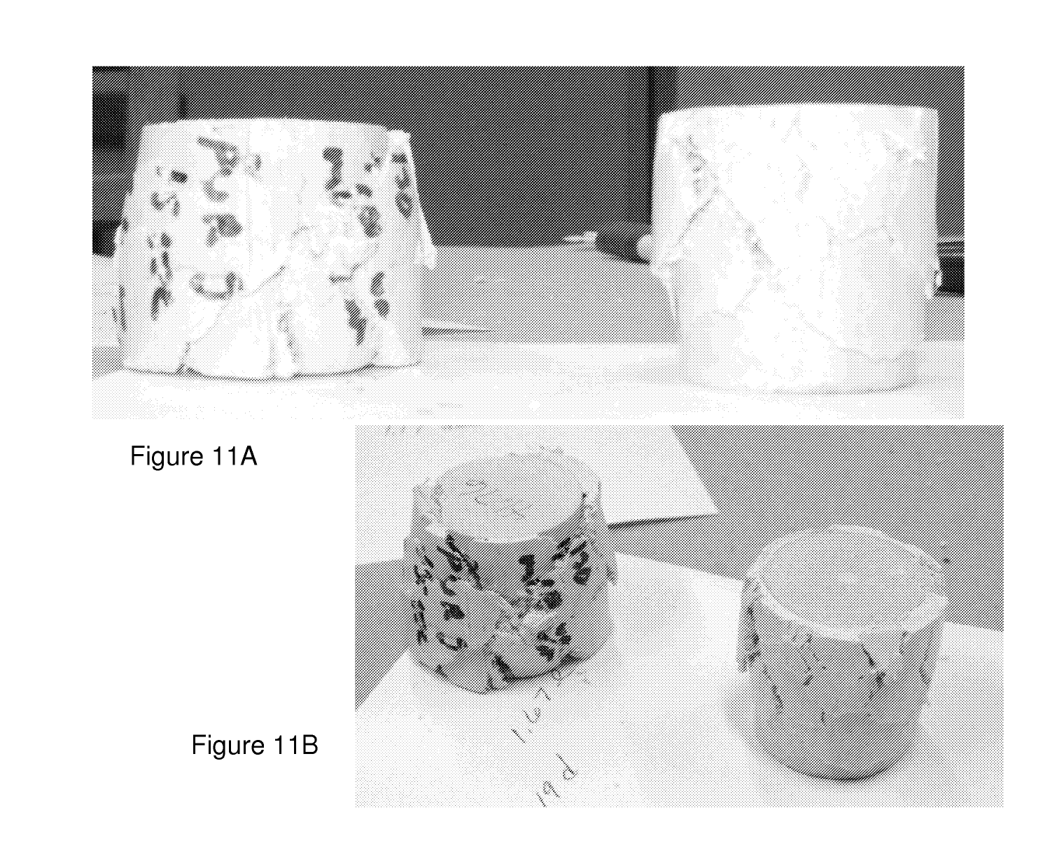

Mix 5, with fibers, shows improved ability to resist fracture during compression. FIG. 10 is a stress strain graph of Mix 5 during compression, and FIGS. 11A and 11B are photographs of Mix 5 after compression. Compression testing in FIG. 10 was terminated before end strain was determined, but instead was terminated according to time constraints. The ratio of terminal stress to ultimate stress is about 50 percent. As can be seen, the cylinder compressed within itself, growing in diameter without fracturing.

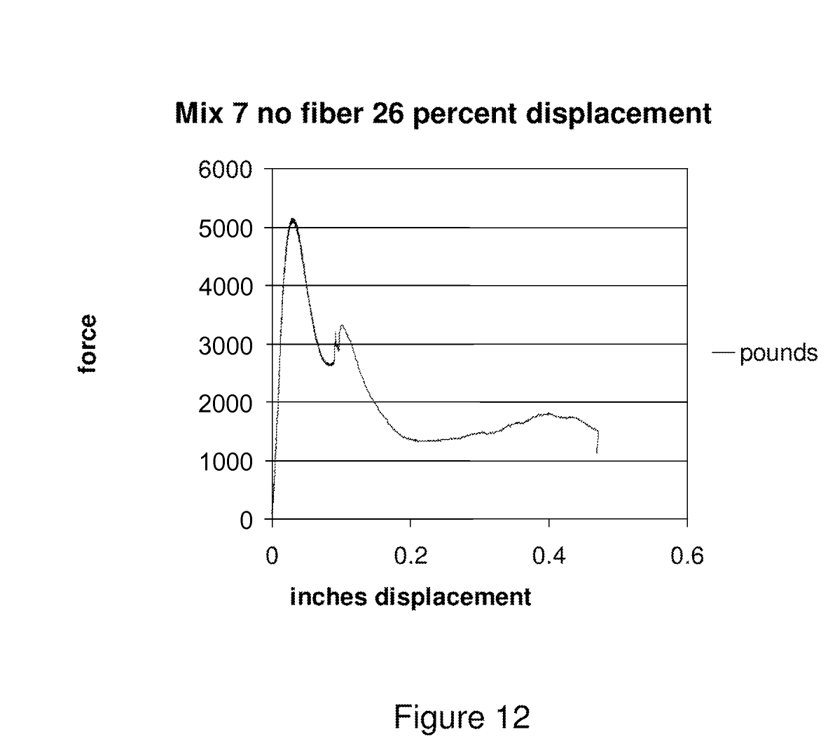

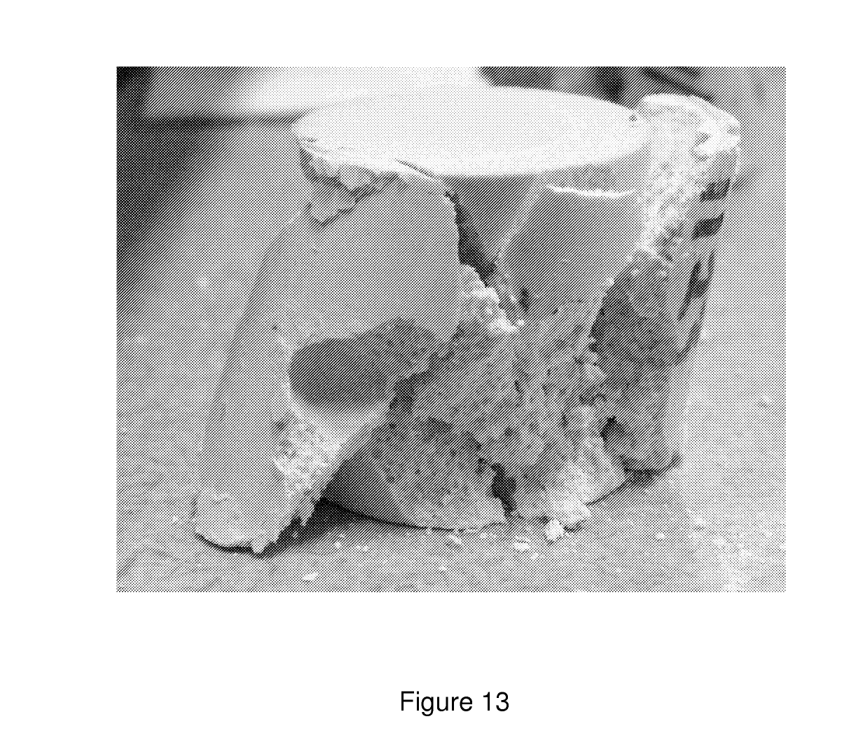

Mix 7, without fibers, still stays together after about 28% deformation and can still carry a 1500 pound load. FIG. 12 is a load-deflection graph of Mix 7 during compression, and FIG. 13 is a photograph of Mix 7 after compression, at failure.

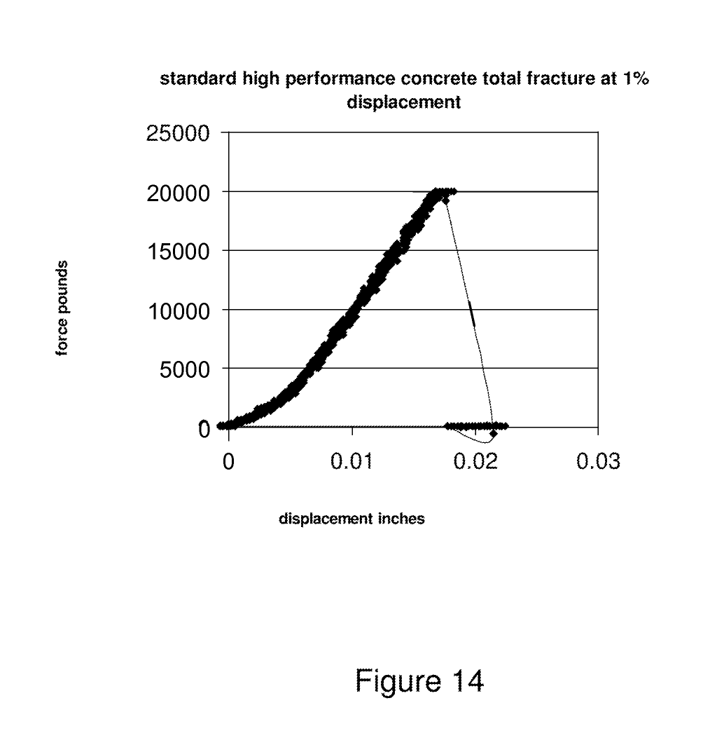

Like FIG. 10, compression testing in FIG. 12 was terminated before the final deformation was determined, but instead was terminated according to time constraints. The ratio of final deflection to ultimate load is about 30 percent without fibers, showing that fibers increase this measure of fracture toughness. FIG. 14 shows a stress strain graph of force versus displacement for a high strength normal sanded aggregate mortar containing silica sand where total destructive fracture occurs at 1% displacement for a normal mortar. The cementitious matrix of the present invention has a greatly improved area under stress strain curve, which is energy absorbtion, relative to regular mortars. As can be seen, certain of these mixtures float in water.

Mixes 4, 5, and 7 have all been used to produce plates reinforced with Kevlar, glass fiber type (including Type S fiber), and carbon fiber fabrics.

Additional examples of formulations of light weight, high performance concrete to the invention are provided in Table 10.

When a cementitious matrix of the present invention is crushed, it sticks together unlike regular concrete which shatters and crumbles. FIG. 11a and 11b are photographs of cylinders which were crushed with 4,000 pounds per square inch. It deformed about 20 percent of its height as shown in the photograph and in FIG. 10. This property is shared among all the mix designs and is improved with the addition of fibers.

TABLE 10

| | Unit # | 10807 | 10907 | 011207-1 | 011207-2 | 011207-3 | 011507-1 | 011507-2 |
|---|---|---|---|---|---|---|---|---|
| CEMENT | g | 590.00 | 150.00 | 100.00 | 100.00 | 100.00 | 60.00 | 120.00 |
| SAND | g | 257.00 | 210.00 | 200.00 | | | 120.00 | 240.00 |
| METAKAOLIN | g | 59.00 | 15.00 | 10.00 | 10.00 | 10.00 | 6.00 | 12.00 |
| PVB-79 | g | | 50.00 | 40.00 | 40.00 | 40.00 | 24.00 | |
| PVA | g | 28.00 | 1.50 | | | | 1.00 | |
| Expanded shale | g | 4.00 | | | | | | |
| GRAVEL | g | 637.00 | | | | | | |
| ACRYLIC | g | | | | | 40.00 | | |
| STYRENE BUTADIENE | g | | 70.00 | 48.00 | 48.00 | | 29.00 | |
| RUBBER | | | | | | | | |
| WATER | g | 245.00 | 10.00 | 30.00 | 2.00 | 5.00 | 18.00 | 40.00 |
| SIKA- | g | 3.00 | 5.00 | 1.00 | 3.00 | 1.50 | 1.00 | 4.00 |
| POLYCARBOXYLATE | | | | | | | | |
| PLASTICIZER* | | | | | | | | |
| SILICON | g | | 0.23 | 0.15 | | | 0.09 | 0.13 |
| CERIUM | g | | | | 0.15 | 0.15 | | |
| WEIGHT | g | 1401.57 | 261.99 | 187.13 | 187.51 | 185.71 | 126.17 | 297.09 |
| VOLUME | cm3 | 695.00 | 206.00 | 125.00 | 125.00 | 125.00 | 125.00 | 125.00 |
| SET VOLUME | | | | | | | | |
| DENSITY | lb/cuf | 125.92 | 79.41 | 93.47 | 93.66 | 92.76 | 63.02 | 148.40 |

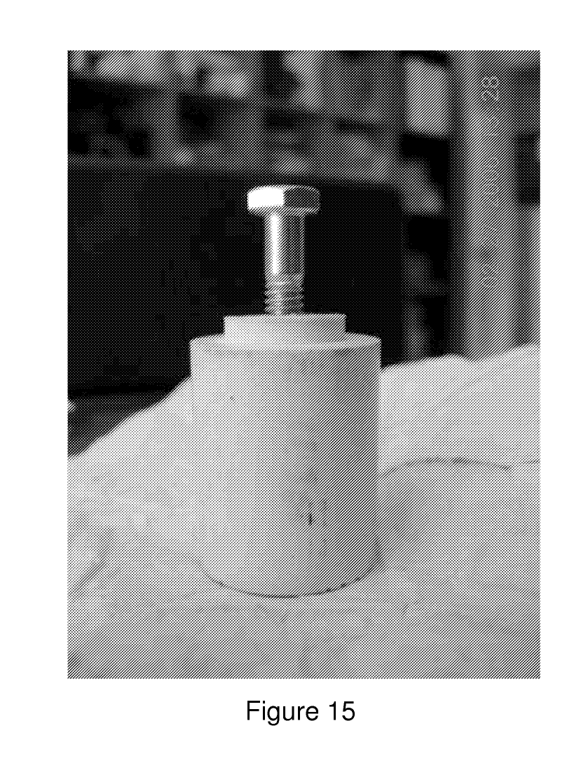

The cementitious matrix can be tapped (tapped threads were strengthened with polyurethane (varnish), and machined with a milling machine and cuts smoothly as shown in Mix 5, FIG. 15. The cementitious matrix does not feel like stone.

Three panels were constructed with PVB, PVA fibered PVB, and non PVB mortars of similar density. A one half inch steel ball was fired a 675 meters/second.

The results are shown in Table 11, indicating a 95 percent reduction in the kinetic energy of the ball when fired against the PVA fibered PVB mix, whereas only a 38 percent reduction was observed with a non PVB mix.

TABLE 11

| Mix | Reduction in kinetic energy |
|---|---|
| Similar density no PVB mix | 38% |
| PVB No Fiber | 80% |
| PVB w/ Fiber | 95% |

### Example 3

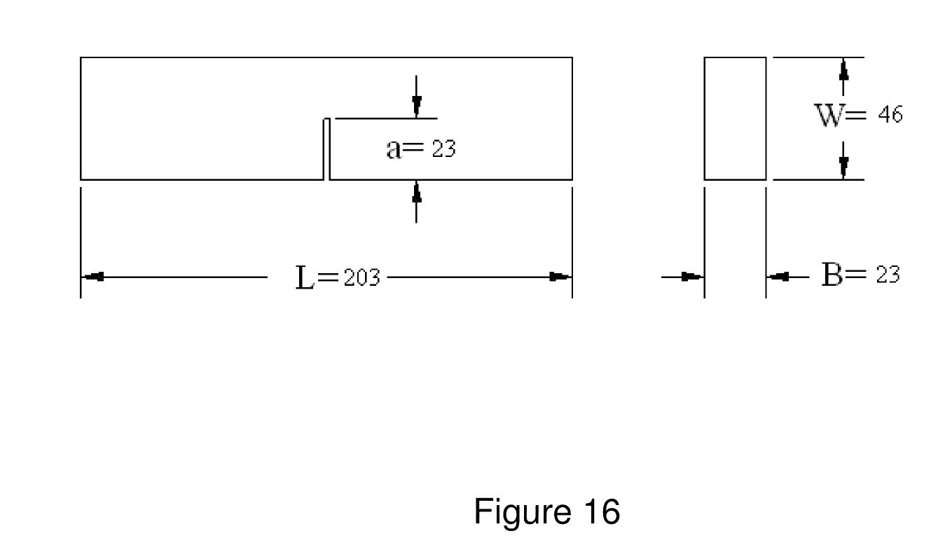

Fracture toughness tests were performed on single edge notch bending (SENB) specimens following ASTM E399. As illustrated to the left in FIG. 16, the test specimens measured 23×46×203 mm (0.9×1.8×8.0 in.). They had a notch height to beam height (a/W) ratio equal to 0.5 and a free span to beam height ratio of 4.0. Specimens were tested in three-point bending, at a loading rate of 33 MPa-m^{0.5}/min (30 ksi-in^{0.5}/min).

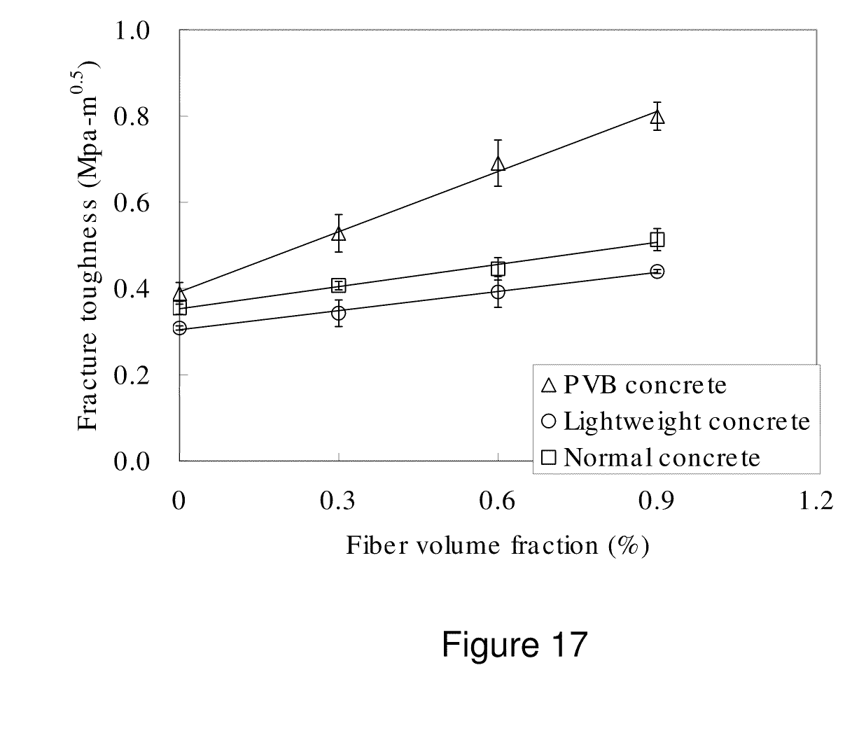

Fracture toughness values for the three materials tested, with and without fiber, are listed in FIG. 17. The points represent average values for three different specimens. In general, the increase in fracture toughness is linear with increasing fiber volume fraction. It is evident for mixes without fiber that the fracture toughness of lightweight concrete and normal weight concrete is slightly lower than that of the PVB composite material. Note that the improvement of fracture toughness with the addition of PVA fiber is significantly greater when compared with the other two groups at the same fiber volume fraction.

Specifically, the fracture toughness of the PVB composite was 0.389, 0.528, 0.691 and 0.800 MPa-m^{0.5} (0.354, 0.481, 0.629 and 0.728 ksi-in^{0.5}) for fiber volume fractions of 0, 0.3, 0.6, and 0.9%, respectively, resulting in improvements ranging from 37% to 108%. This trend indicates that the PVB composite has higher interfacial bond strength as compared to the other two materials.

In order to calculate the fracture toughness from Eq. 18, it is necessary to obtain the interfacial bond strength, τ. The latter is defined as the friction between the fiber and the matrix and this is affected by many factors.

Although the ultimate tensile strength is not measured directly herein, it can be estimated by the modulus of rupture R. Moreover, it is assumed that the tensile strength and the modulus of rupture of fiber reinforced concrete are very similar to those of plain concrete, since the volume fractions are relatively low (<2%).

As discussed above, the tensile stress at the extreme fiber in the mid span can be expressed as the summation of the tensile stress of the matrix and the fiber. Hence, the interfacial bond strength can be obtained from Eq. 10, provided that a flexural test is done to obtain the flexural stress, σₘ.

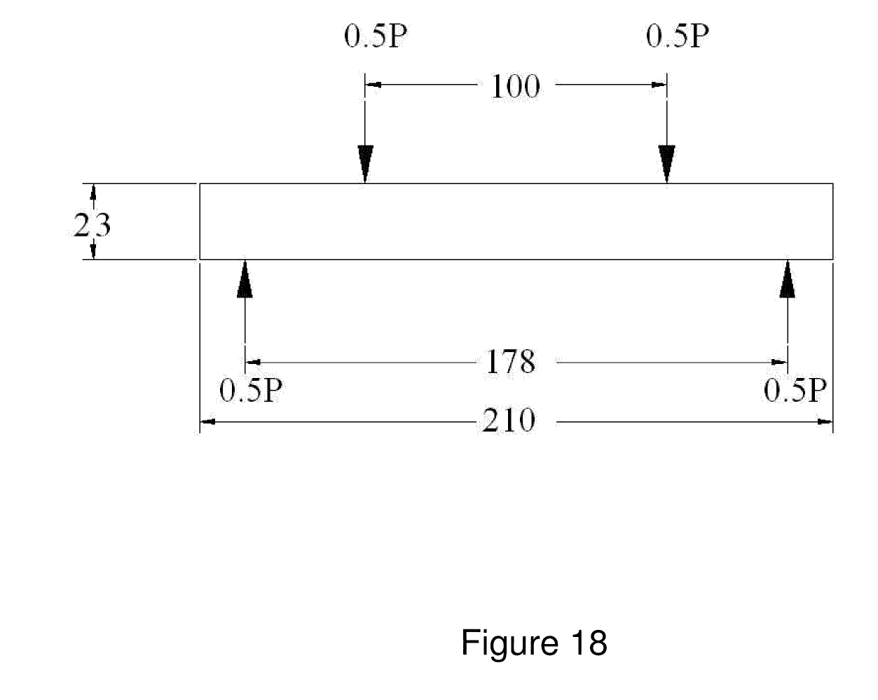

To that end, and as illustrated in FIG. 18, the flexural stress was measured by placing test specimens in third point bending. The specimens, which measured 70×25×210 mm (2.75×1×8.25 in.), were loaded at a rate of 667 N/min (150 lb/min), corresponding to a stress increase at the bottom surface (tensile side of the beam) of 2.1 MPa/min (308 psi/min).

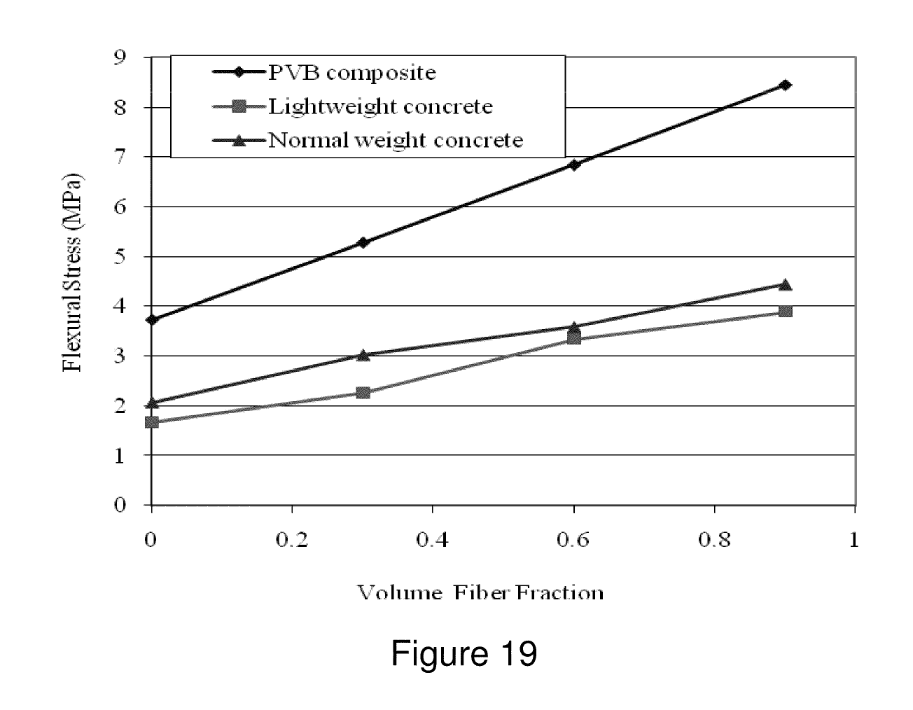

FIG. 19 shows the flexural stress for the three materials tested, with and without fiber. In general, this quantity increases with volume fiber fraction. The increase is more significant in the PVB composite, as compared to lightweight and regular concrete.

Table 12 shows the shear bond strength for the three materials tested, with and without fiber. It is evident that the PVB mix has a higher interfacial bond strength than that of lightweight and normal concrete.

TABLE 12

| | Flexural stress σ (MPa) | | | | | | τ |
|---|---|---|---|---|---|---|---|
| | V_{f} = 0% | V_{f} = 0.3% | V_{f} = 0.6% | V_{f} = 0.9% | g* | L_{f}/d_{f} | (MPa) |
| PVB composite | 3.73 | 5.28 | 6.84 | 8.44 | 1.5 | 200 | 3.46 |
| Lightweight concrete | 1.67 | 2.26 | 3.35 | 3.89 | 1.5 | 200 | 1.61 |
| Normal weight concrete | 2.06 | 3.02 | 3.58 | 4.44 | 1.5 | 200 | 1.86 |

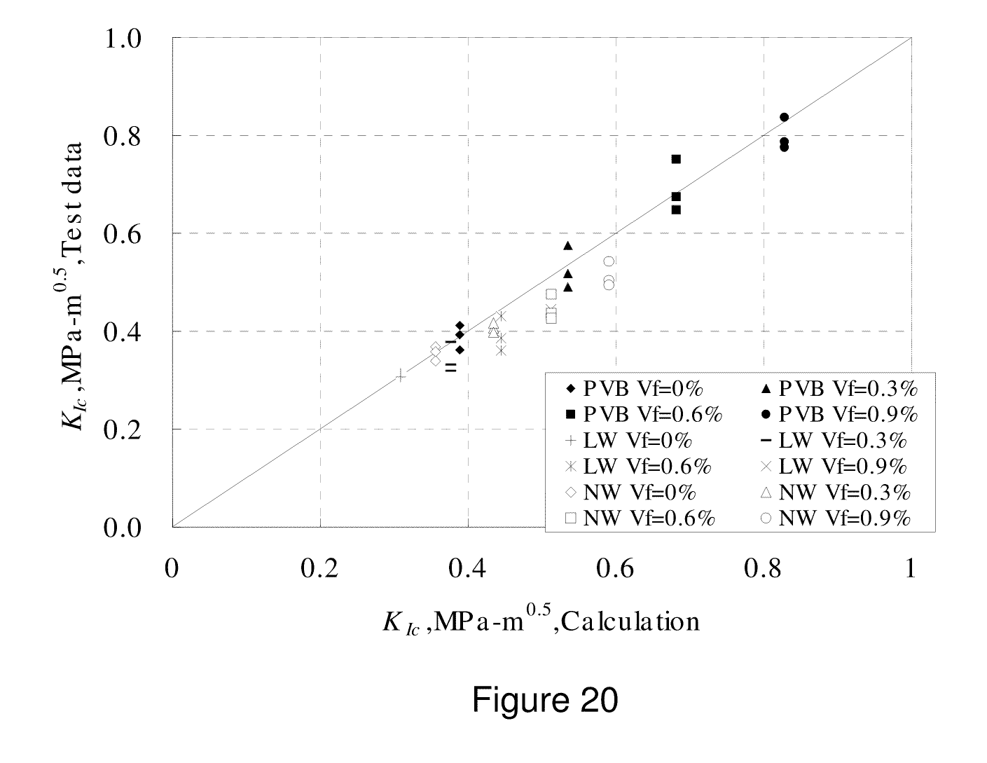

Table 13 shows the results of the fracture toughness data calculated from Eq. 18 expressed as a function of the fiber volume fraction. Table 14 lists the theoretical results obtained from these expressions along with the average values obtained from the tests. FIG. 20 includes data taken from all specimens (3) of each type, clearly illustrating that the results from the model compare well with the test data.

TABLE 13

| | P₀ | | | τ | K_{Ic} |
|---|---|---|---|---|---|
| | (N) | g* | L_{f}/d_{f} | (MPa) | (MPa-m^{0.5}) |
| PVB composite | 178.4 | 1.5 | 200 | 2.82 | 0.39 + 48.8 V_{f} |
| Lightweight concrete | 141.6 | 1.5 | 200 | 1.31 | 0.31 + 22.6 V_{f} |
| Normal weight concrete | 163.1 | 1.5 | 200 | 1.52 | 0.36 + 26.1 V_{f} |

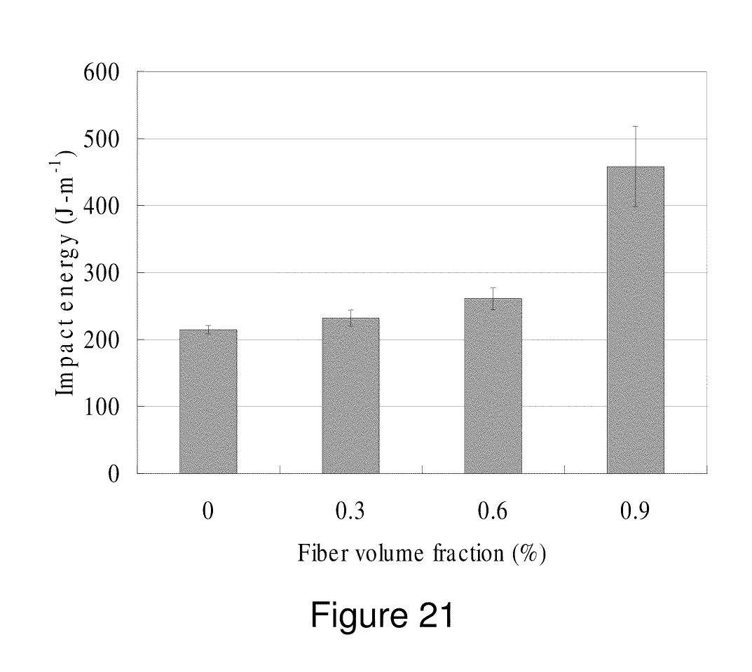

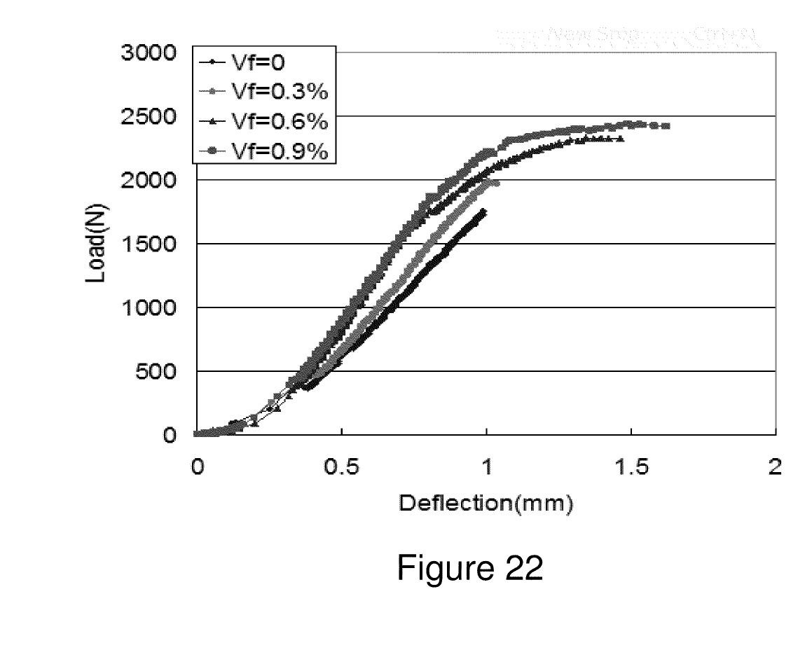

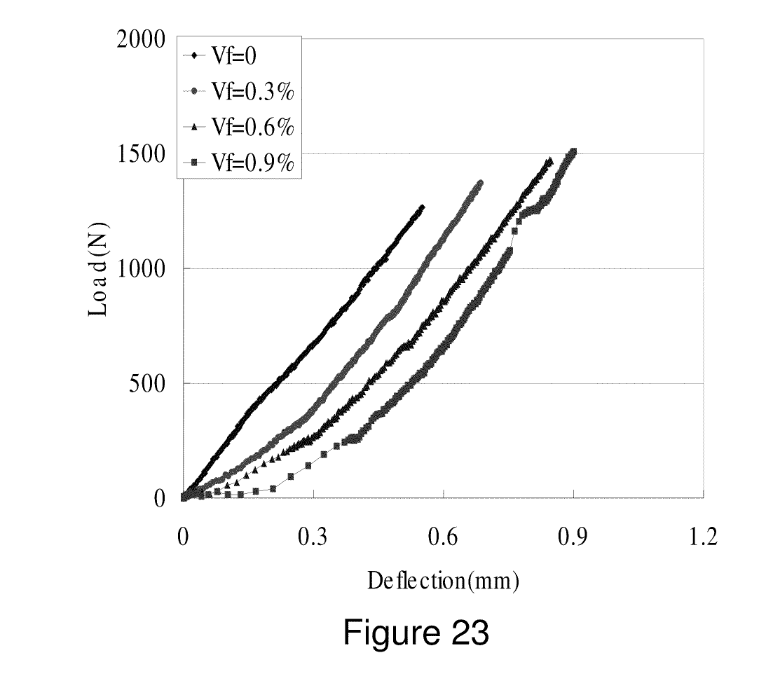

FIGS. 21, 22, and 23 show additional properties of compositions of the present invention as a function of the percentage of PVA fibers in the composition. FIG. 21 shows that impact energy increases with increasing amounts of PVA fibers up to 0.9%. FIG. 22 shows PVB mortar load as a function of deflection increasing with increasing amounts of PVA fibers up to 0.9%. FIG. 23 shows load as a function of deflection decreasing with increasing amounts of PVA fibers up to 0.9% for a lightweight silica aggregate mortar.

TABLE 14

| | | Fracture toughness (MPa-m^{0.5}) | | | |
|---|---|---|---|---|---|
| | Source | V_{f} = 0% | V_{f} = 0.3% | V_{f} = 0.6% | V_{f} = 0.9% |
| PVB | Calculation | 0.389 | 0.535 | 0.682 | 0.828 |
| concrete | Test | 0.389 | 0.528 | 0.691 | 0.800 |
| Lightweight | Calculation | 0.309 | 0.377 | 0.445 | 0.512 |
| concrete | Test | 0.309 | 0.343 | 0.392 | 0.440 |
| Normal | Calculation | 0.356 | 0.434 | 0.513 | 0.591 |
| weight | Test | 0.355 | 0.407 | 0.446 | 0.514 |
| concrete | | | | | |

The above experiments show a new method for producing lightweight cementitious materials for use with high tensile high stiffness fiber and cloth reinforced materials or alone or with PVA, polypropylene, or bi- or tri-polymer fibers. In some mix designs, cenospheres have been added to reduce density. The method relies on the interfacial bond developed by generating a formulation including a high percentage, by weight, of the aggregate (PVB) and reinforcement (PVA fiber) to improve a combination of mechanical properties (e.g. tensile strength, ductility, fracture toughness, and impact resistance). The addition of PVA fibers decreases slightly the compressive strength but improves the flexural strength, ductility, fracture toughness, and impact resistance. The increase in fracture toughness was found to be linear with increasing fiber volume fraction; the increase associated with impact resistance was non-linear. The significant improvements in these parameters indicate that fibers play important roles in resisting dynamic loads.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What we claim is:

1) A cementitious mix comprising:
a) a cement; and
b) an aggregate which includes at least 1% by weight of the total weight of the cementitious mix, of poly(vinyl butyral).

2) The cementitious mix of claim 1 further comprising water to form a cementitious matrix.

3) The cementitiuos matrix of claim 2 further comprising a reinforcing material.

4) The cementitious matrix of claim 3 wherein the amount of poly(vinyl butyral) is at least 1% to about 50%, by weight of the total weight of the cementitious mix.

5) The cementitious matrix of claim 4 wherein the amount of poly(vinyl butyral) is from about 10% to about 55%, by weight of the total weight of the cement cementitious matrix.

6) The cementitious matrix of claim 3 wherein the reinforcing material is selected from the group consisting of plastics, resins, ceramics, glass fibers, aramid fibers, carbon fibers and poly(vinyl alcohol).

7) The cementitious matrix of claim 6 wherein the reinforcing material is poly(vinyl alcohol).

8) The cementitious matrix of claim 7 wherein the poly(vinyl alcohol) is present in an amount of from about 0.1% to about 3%, by weight of the total weight of the cementitious matrix.

9) The cementitious matrix of claim 8 wherein the poly(vinyl alcohol) is present in an amount of about 0.9%, by weight of the total weight of the cementitious matrix.

10) The cementitious matrix of claim 2 further comprising cerium oxide in an amount of about 0.01% to about 1%, by weight of the total weight of the cementitious matrix.

11) The cementitious matrix of claim 2 further comprising metakaolin in an amount up to about 5%, by weight of the weight of the cement in the cementitious matrix.

12) The cementitious mix of claim 1 further comprising pozzolan in an amount of up to 10%, by weight of the weight of the cement in the cementitious mix.

13) The cementitious matrix of claim 2 further comprising silica fume in an amount up to about 10% by weight of the weight of the cement in the cementitious matrix.

14) The cementitious matrix of claim 2 further comprising a superplasticizer in an amount up to about 3%, by weight of the total weight of the cementitious matrix.

15) The cementitious matrix of claim 14 wherein the superplasticizer is polycarboxylate.

16) The cementitious matrix of claim 2 further comprising an aqueous latex in an amount of from about 10% to about 50%, by weight of the total weight of the cementitious matrix.

17) The cementitious matrix of claim 16 wherein the latex compound is selected from the group consisting of a styrene butadiene latex, a PVAC, PVOH, EVAC or EVOH latex and an aqueous latex.

18) A method of increasing tensile strength of a cementitious mix comprising adding poly(vinyl butyrate) to the cementitious matrix in an amount of at least 1%, by weight of the total weight of the cementitious mix.

19) The method of claim 18 wherein the amount of poly(vinyl butyrate) is present in an amount of at least 1% to about 50%, by weight of the total weight of the cementitious matrix.

20) A cementitious matrix comprising:
a) a cement;
b) an aggregate material;
c) a fiber reinforcing material that binds to the aggregate material; and
d) water.

21) The cementitious matrix of claim 20 wherein the aggregate material is poly(vinyl butyral) in an amount of at least 1% to about 50%, by weight of the total weight of the cementitious matrix, the fiber reinforcing material is poly(vinyl alcohol) in an amount of about 0.1 to about 3%, by weight of the total weight of the cementitious matrix and the water is present in an amount of about 25% or greater, by weight, based on the weight of the cement.

22) A cementitious mix comprising:
a) a cement; and
b) an aggregate comprising a material including surface hydroxyl groups and ether groups, wherein the material is present in an amount of at least 1% by weight of the weight of the cementitious mix.
